(19) United States
(12) Patent Application Publication
(10) Pub. No.: US 2004/0216929 A1
(43) Pub. Date: Nov. 4, 2004

(54) Solar powered transporter with stabilized speed control and clutch controlled steering

(76) Inventor: Catherine White, Los Angeles, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/427,437

(22) Filed: Apr. 30, 2003

(51) Int. Cl. B60L 8/00

(52) U.S. Cl. 180/2.2

(57) ABSTRACT

A scooter type apparatus having a platform for supporting a person, wheels engaging the platform in rolling motion, a handlebar extending upwardly from the platform for stabilizing the person and for controlling rotational speed of two rearwardly positioned of the wheels, electrical clutches for each of the rear wheels, and an electrical circuit including a battery, a plurality of solar cells fixed to the platform and the handle bar, an electric motor and a motor speed control, including, dual operational amplifiers in a push-pull configuration, a tachometer for speed stabilizing, and a potentiometer input. The electrical circuit charges the battery and drives the rear wheels so that with both of the wheels driven in the same sense, the apparatus moves in a forward or rearward straight line, and with one of the clutches disengaged the apparatus is caused to turn left or right. The forward wheels are castors.

### RELATED APPLICATIONS

This is a substitute application of a prior filed application having Ser. No. 09/990,058 and file date of Nov. 20, 2001.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to stand-up personal transporter devices, and more particularly to such a personal transporter with stabilized speed control and clutch controlled steering.

2. Description of Related Art

The following art defines the present state of this field:

Hsich et al., U.S. Pat. No. 5,816,604 describes a stretchable and foldable cart whose handle bar can be stretched, retracted or folded by operation of a pressing rod associated with positioning elastic lugs, pins and stoppers. The loading stage of the car is able to adjust its size according to actual requirements by the operation of push button, positioning stoppers and connecting rods. The front and rear mountings of cart are made of plastics with sufficient engineering strength for reducing the cart weight yet without affecting the cart's functions; facilitating assembly work and reducing production cost.

Catto, U.S. Pat. No. 5,894,898 describes an electric, three-wheeled motor scooter, which can derive its motive energy either from a solar-electric array on the vehicle or an independent source of electric power. The vehicle has a unique suspension which permits limited lateral rotation of the forward portion of the vehicle relative to the rear portion, and thereby, facilitates handling and ease of use. Speed and acceleration are controlled through a modulated pulse width controller which supplies pulses of electrical energy to the DC motor in response to throttle commands.

Golichowski et al., U.S. Pat. No. 6,024,376 describes a platform truck for transporting items including a base member having a top surface to received the items thereon. A handle assembly is pivotally carried by the base member and is thereby positionable in a generally upright position for pushing the base member, a generally outward position for pulling the base member, and a generally horizontal position generally flush with the top surface of the base member. Opposed side wall assemblies extend generally vertically downwardly from the top surface of the base member and have opposed depressions therein. Side wall assemblies also carry a latch assembly. When the handle assembly is in the generally horizontal position, latch assembly holds arms of the handle assembly which can be grasped at the location of at least one of the depressions for carrying the platform truck. The base member is supported by a plurality of casters, the front casters being carried by a caster support system which permits the front casters to be mounted to the base member for either unidirectional movement or fully swivelable movement of the front casters.

The prior art teaches various designs in personal transport devices. However, the prior art does not teach that a personal transport device with castor front wheels and driven rear wheels with clutch release steering and potentiometer speed control through a tachometer stabilized, push-pull operational amplifier, voltage control both full positive and full negative. The present invention fulfills these needs and provides further related advantages as described in the following summary.

### SUMMARY OF THE INVENTION

The present invention teaches certain benefits in construction and use which give rise to the objectives described below.

The present invention provides a solar powered and portable transporter. This transporter is especially suited for assisting the elderly by providing them with added mobility. The benefit of this invention over the prior art is that the transporter is designed so the user can stand on the transporter at about the same height as other pedestrians and stability and operation is very simple. The transporter is in the form of a scooter having a platform for supporting a person, wheels engaging the platform in rolling motion, a handlebar extending upwardly from the platform for stabilizing the person and for controlling rotational speed of two rearwardly positioned of the wheels, electrical clutches for each of the rear wheels, and an electrical circuit including a battery, a plurality of solar cells fixed to the platform and the handle bar, an electric motor and a motor speed control, including, dual operational amplifiers in a push-pull configuration, a tachometer for speed stabilizing, and a potentiometer input. The electrical circuit charges the battery and drives the rear wheels so that with both of the wheels driven in the same sense, the apparatus moves in a forward or rearward straight line, and with one of the clutches disengaged the apparatus is caused to turn left or right. The forward wheels are castors. The advantage of using this operational amplifier, tachometer stabilized voltage control is the enabling of full rail-to-rail voltage swing across the motor in either direction for forward and reverse motion control.

A primary objective of the present invention is to provide a solar powered personal transporter having advantages not taught by the prior art.

Another objective is to provide such a personal transporter that is extremely easy to operate.

A further objective is to provide such a personal transporter that receives much of its power from sunlight enabling it to extend its operating range and enhance velocity.

A still further objective is to provide such a transporter that is able to be steered by idling one of two drive wheels while powering the opposing one of the wheels.

Other features and advantages of the present invention will become apparent from the following more detailed description, taken in conjunction with the accompanying drawing figures, which illustrate, by way of example, the principles of the invention.

### BRIEF DESCRIPTION OF THE DRAWING

The accompanying drawings illustrate the present invention. In such drawings:

FIG. 1 is a perspective view of a preferred embodiment of the present invention;

FIG. 2 is a plan view of the bottom thereof;

FIG. 3 is an electrical schematic diagram thereof; and

FIG. 4 is an electrical schematic diagram of the control shown in FIG. 3.

### DETAILED DESCRIPTION OF THE INVENTION

The above described drawing figures illustrate the invention, a battery powered portable transporter 10 particularly suitable for elderly persons who need assistance in walking excessive distances. The transporter 10 consists of a platform 20 preferably having dimensions large enough to stand on, and made of a material that is rigid, durable, and light in weight. The platform 20 is preferably 18 inches long and 12 inches wide.

A plurality of wheels 30A, 30B are rotatably attached to the platform 20 as shown in FIG. 1. The plurality of wheels preferably includes a pair of front wheels 30A and a pair of rear wheel means 30B. The front wheels 30A preferably are castor type wheels that will turn when urged to do so. The pair of rear wheels 30B are preferably located to the side of the platform 20, as shown in FIG. 1, so they do not interfere with the rider's feet while standing on the platform 20.

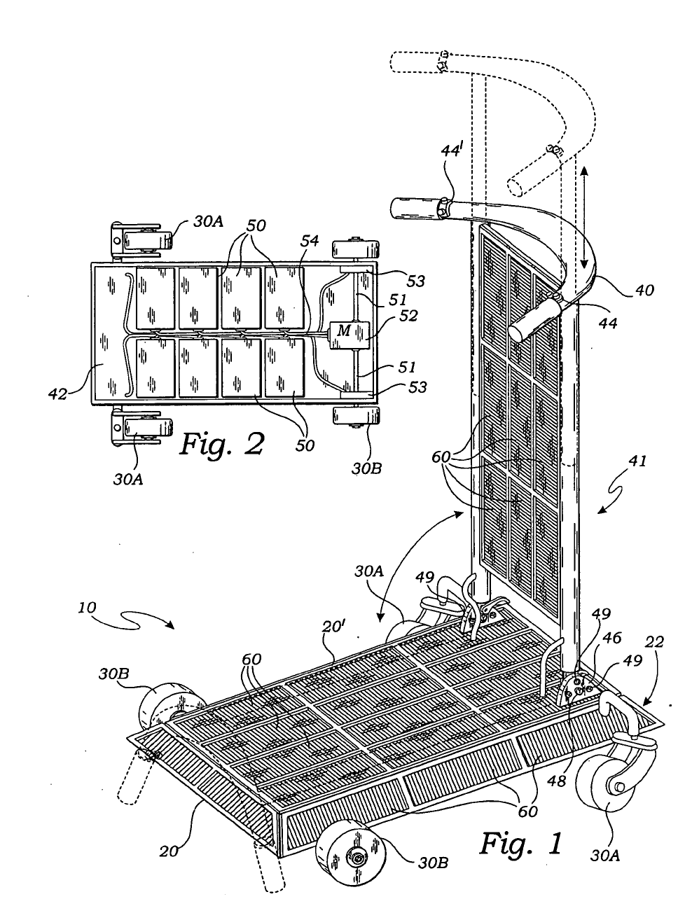

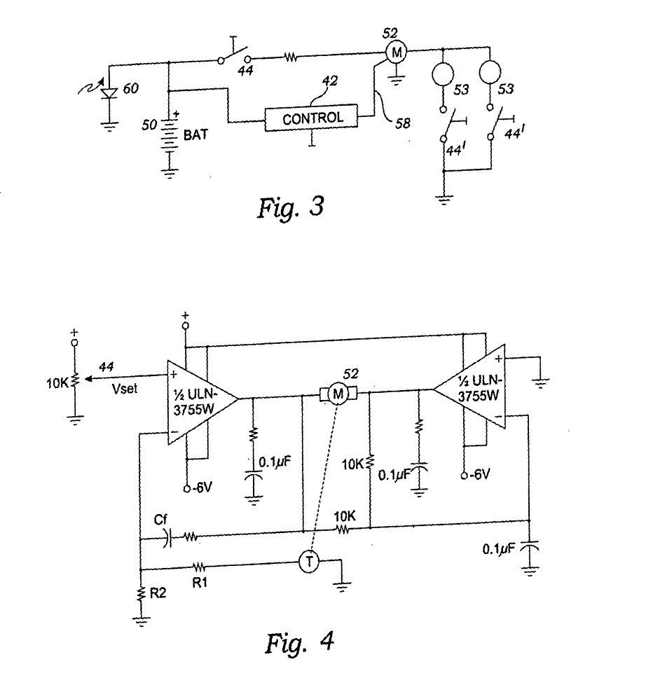

As shown in the schematic diagram of FIG. 3, a battery 50 (BAT) is electrically connected, preferably with insulated power cables 54 (FIG. 2), to electric motor 52. In its preferred embodiment, the battery 50 is a plurality of rechargeable nickel-cadmium type cells or equivalent, and is attached to the underside of the platform 20 with any common fastening means well known in the art. As shown in FIG. 2, the electric motor 52 is mechanically engaged for driving, wheels 30B by shafts 51 and electric clutches 53. One or both of the clutches 53 are able to be disengaged by the rider so that one or the other of the rear wheels 30B are able to move the apparatus to left or right, for instance, with only the left wheel driving, the apparatus will turn to the right.

A handle bar assembly 41 is preferably a collapsible telescoping structure as shown in FIG. 1, and is also pivotally attached to the front end 22 of the platform 20 with a pair of hinging brackets 46 and hinging bolts 48. Each hinging bracket 46 preferably has two or more locking bolt holes 49 which accept a locking bolt for locking the handle bar 40 into either an upright (shown), rearwardly folded (shown in phantom lines) or forwardly folded position (not shown). FIG. 1 shows the upright position of the handle bar 40 which allows the user to ride the transporter 10 holding onto the handle bar 40 for stability. A control circuit 42, as shown in FIG. 3 and detailed in FIG. 4, provides the user with control over the direction in which the transporter 10 moves, i.e., forward or reverse, as well as the direction in which it turns. The control 42 is interconnected with the battery 50 and with the motor 52, and provides the rider with control over the motor 52 as well as electric clutches 53. The handle bar 40 includes a operating control 44 preferably buttons which engage power to the motor and control motor speed and sense, i.e., forward or reverse, and buttons 44′ preferably provide steering by enabling one of the drive wheels 30B to disconnect via its associated clutch 53, while maintaining engagement of the other clutch 53.

In use, the user simply stands on the platform means 20 and guides the transporter 10 to the desired destination at a selected speed. When the transporter 10 is not needed, the platform 20 is pivoted 90 degrees with respect to the position shown in FIG. 1, i.e., laid-down onto the platform 20. Then, the handle bar 40 is collapsed, preferably through telescoping action. The locking bolt 49 then locks into the hinging bracket 46 to maintain the apparatus in this configuration, wherein the apparatus my be placed in, for instance, in the trunk of a car. With the handle bar 40 rotated into a forward position, the apparatus is easily pulled along behind as one walks.

Solar panels 60 are positioned on the platform 20, on the handlebar assembly 41 and on side edges of the platform 20 which are positioned at a 45 degree angle to the platform top surface 20′. These panels 60 are electrically interconnected in series-parallel circuits to achieve the necessary voltage for recharging battery 50 through a recharging circuit which is part of the control 42. The control 42 is wired to drive motor 52 and electric clutches 53.

The electrical circuit of the apparatus comprises, as stated, components including the battery 50, the solar cells 60; the electric motor 52 and clutches 53, and the control 42. The control 42 includes, dual operational amplifiers ULN-3755W, in a push-pull configuration as shown in FIG. 4, a tachometer T mechanically engaged for speed stabilizing, and a wiper engaged 10K potentiometer input shown at extreme left in FIG. 4. The electrical circuit components are interconnected as shown in FIGS. 3 and 4, for charging the battery 50 and driving the rear wheels 30B so that with both of the rear wheels driven in the same rotational sense, the apparatus moves in a forward or rearward straight line, and with only one of the clutches 53 engaged, the apparatus is caused to turn left or right. In FIG. 4, Cf and Rf are selected so that an RfCf time constant prevents system oscillation by compensating for inherent dynamic mechanical lag in the motor 52.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An apparatus comprising: a platform for supporting a person standing on the platform; a plurality of wheels engaging the platform in rolling motion; a handlebar extending upwardly from the platform for stabilizing the person and for controlling speed of two of the wheels; and an electrical circuit engaging the apparatus; the electrical circuit comprising components: a battery, a plurality of solar cells fixed exteriorly to the platform and the handle bar for receiving ambient light energy; an electric motor engaged with the wheels; and a means for motor speed control; the motor speed control means including, dual operational amplifiers in a push-pull configuration, a tachometer functionally engaged for speed stabilizing, and a potentiometer input drawing power from the battery; the electrical circuit components interconnected for charging the battery and for driving the two of the wheels.

2. The apparatus of claim 1 wherein a forward pair of the wheels are a castor type wheel.

3. The apparatus of claim 1 wherein the operational amplifiers are ULN3755W amplifiers.

4. The apparatus of claim 1 wherein the potentiometers are mounted on the handlebar for controlling speed.

5. The apparatus of claim 1 wherein an RfCf time constant is selected to prevent system oscillation by compensating for inherent dynamic mechanical lag in the motor.

6. An apparatus comprising: a platform for supporting a person standing on the platform; the platform mounted on two castor wheels forward, and two drive wheels rearwardly; a plurality of wheels engaging the platform in rolling motion; a handlebar extending upwardly from the platform for stabilizing the person and for controlling speed of two of the wheels; and an electrical circuit engaging the apparatus; the electrical circuit comprising components: a battery, an electric motor engaged with two of the wheels through electric clutches; and a means for motor speed control; the motor speed control means including, dual operational amplifiers in a push-pull configuration, a tachometer functionally engaged for speed stabilizing, and a potentiometer input drawing power from the battery; the electrical circuit components interconnected for charging the battery and for driving the two of the wheels.

7. The apparatus of claim 6 wherein the electrical clutches are interconnected for disengagement by a control mounted on handlebar.

8. The apparatus of claim 6 wherein the potentiometer is mounted on the handlebar for controlling speed.

9. The apparatus of claim 6 wherein an RfCf time constant is selected to prevent system oscillation by compensating for inherent dynamic mechanical lag in the motor.
